(19) United States
(12) Patent Application Publication
(10) Pub. No.: US 2021/0163157 A1
(43) Pub. Date: Jun. 3, 2021

(54) Artificial Ring, Solenoid System to Terraform

(71) Applicants: Olatunbosun J. Osinaike, Chicago, IL (US); Olatunde M. Osinaike, Silver Spring, MD (US); Peter Patterson, Mount Pleasant, WI (US)

(72) Inventors: Olatunbosun J. Osinaike, Chicago, IL (US); Olatunde M. Osinaike, Silver Spring, MD (US); Peter Patterson, Mount Pleasant, WI (US)

(21) Appl. No.: 17/107,945

(22) Filed: Nov. 30, 2020

Related U.S. Application Data
(60) Provisional application No. 62/942,228, filed on Dec. 2, 2019.
(60) Provisional application No. 63/007,942, filed on Apr. 9, 2020.

(51) Int. Cl. B64G 99/00; A01G 15/00

(52) U.S. Cl. CPC B64G 9/00; A01G 15/00

(57) ABSTRACT

A ring, solenoid system can be utilized to terraform planetary conditions so that they remain hospitable to human life. Particles may help gases condense, by serving as condensation and deposition nuclei for gases in a thin atmosphere. An electrically conductive ring may be placed around Mars, to grant it an oppositional magnetic field, and protect it from the Sun's Solar Wind. Solenoids, which are rings with multiple loops, may also be used to amplify a planet's magnetic field, as solenoids can enhance magnetic field strength.

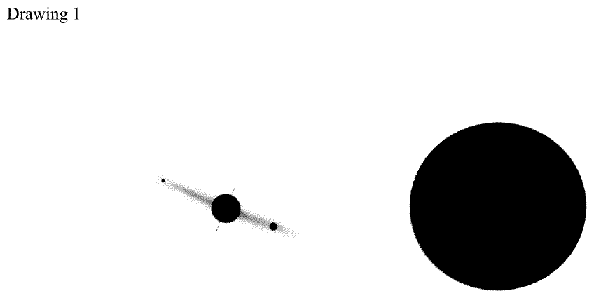

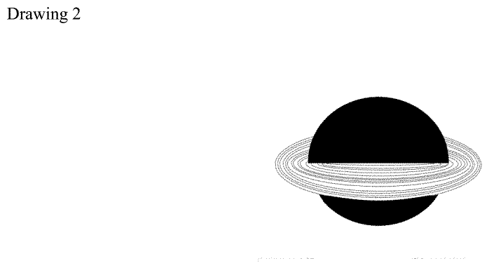

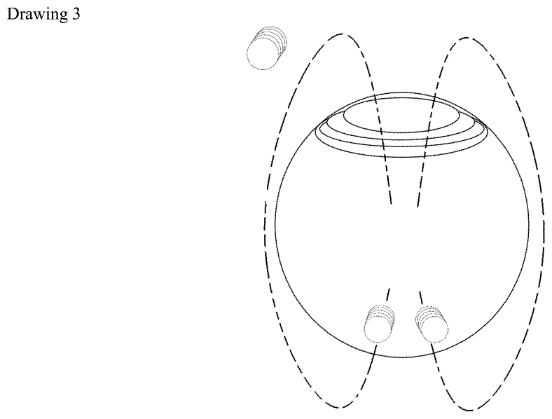

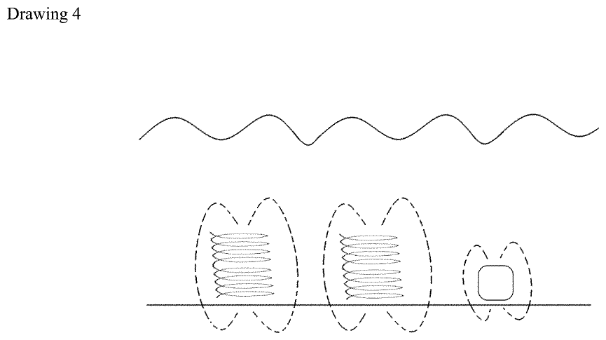

### CROSS REFERENCE TO RELATED APPLICATIONS

Provisional 62/942,228

Filing Date Dec. 2, 2019

Provisional 63/007,942

Filing Date Apr. 9, 2020

### BACKGROUND OF THE INVENTION

Terraforming is the process of altering a planet, to make it compatible to human life. This invention pertains to creating artificial ring systems, and solenoids, to help make atmospheric conditions compatible for human life. Earth and Mars are the primary candidates for terraforming.

### BRIEF SUMMARY OF THE INVENTION

An artificial ring, solenoid system may be utilized to terraform a planet in multiple ways. A ring system, comprised of particles, may serve as a supply of condensation and deposition nuclei, to retain atmospheric gases. An electrically conductive ring can be used to generate a magnetic field, to shield a planet from the Sun's Solar Wind, and Galactic Cosmic Rays. A ring which conducts electricity and generates a magnetic field, can also create oppositional magnetic field in response to a changing external magnetic field. If an electrically conductive ring is used to create an artificial magnetic field around a planet, a second ring comprised of particles may be serve as an insulator, placed within an outer electrically conductive ring, to shield a planet from the current flowing through the conductive ring.

An artificial ring or solenoid system does not need to encircle the planet, in order to make it suitable for human life. Solenoids may be placed near the magnetic center of a planet, in order to amplify its magnetic field in regions where the field is weak. Solenoids, placed in the ionosphere of a planet's atmosphere, can also be used as an artificial heat sink. By placing an electrically conductive solenoid system in or around the ionosphere of Earth, a ring system comprised of material with low thermal conductivity, can reduce the joule heating caused by the interaction between the Sun's Solar Wind and Earth's magnetosphere.

### BRIEF DESCRIPTION OF THE DRAWINGS

Drawing 1 is a demonstration of a ring system, from the side, and what a ring system of particles would look like.

Drawing 2 also demonstrates how a ring system might appear around a planet.

Drawing 3 is a demonstration of a planet's magnetic field, and how solenoids (not to scale) might amplify a planet's magnetic field.

Drawing 4 demonstrates how solenoids might amplify a planet's magnetic field, by resting on the surface, or ocean floor.

### DETAILED DESCRIPTION OF INVENTION

Mars, which has become one of the primary candidates for terraforming, lacks sufficient atmosphere to accommodate life. The purpose of terraforming the Martian atmosphere is to help mitigate atmospheric loss on the planet. Retaining atmosphere is vital to increasing pressure, enabling greenhouse convective warming, and making the planet accommodating to life. To address this issue, the inventors of this patent disclosure propose creating an artificial ring system to help terraform Mars.

Mars is vulnerable to atmospheric loss, caused by the Sun's solar wind. As a result, Mars lacks atmospheric pressure, and has a very thin atmosphere. There are two primary purposes of placing a ring system around Mars. For one, particles in a ring system around Mars, will serve as condensation and deposition nuclei for vapors in Mars' atmosphere, making it more difficult for the gases to escape its atmosphere. Secondly, placing an artificial ring system around Mars, which conducts electricity, will help shield the planet from the Sun's magnetic field.

At the same time, Earth's atmosphere is experiencing too much warming, which makes the planet's conditions hostile towards human life. To address this issue, the inventors of this disclosure propose utilizing a solenoid system to amplify regions of magnetic weakness, such as the South Atlantic Anomaly. Solenoids may also be placed in the ionosphere can be placed in the ionosphere, to operate as a heat sink, conducting heat away from the planet's atmosphere into space, and mitigating joule heating caused by the electrical currents in Earth's ionosphere. An artificial ring system may be placed in Earth's ecliptic plane, to help shade the planet from sunlight.

The principles of orbit and planetary motion are key to this invention. Objects in orbit of another, rotate around their center of mass. This center of mass is known as the barycenter. The barycenter for most satellites orbiting a planet, remains inside the planet, due the planet's larger mass.

One purpose of building an artificial planetary ring system, is to help retain atmospheric gases. Since objects in orbit rotate around the barycenter, extending the planet's reach with a ring system, helps retain atmosphere, as the ring system particles serve as condensation nuclei, and deposition nuclei, for the gases higher in the atmosphere, which are orbiting the barycenter.

Ring system particles are essential to binding vapor, helping deposition and condensation, and seeding vapor with nuclei, so that the molecules gain mass, and return back to the planet. Ring systems are seen on many of the gaseous planets, which reside beyond the frost line. However, terrestrial planets don't have natural ring systems, because they do not reside beyond the frost line in the Solar System. The frost line is the point in the Solar System beyond which most gases are cold enough to freeze into solids. Within the frost line, gases are not quite cold enough to freeze in space, especially without condensation nuclei. It is important to understand that vapor does not always freeze at its freezing temperature. Vapor normally needs a nucleus in order to freeze. Vapor lacking condensation/deposition nuclei can exist in a non-solid, gaseous state, even below the gas' freezing point. This is called a supercooled vapor.

For this reason, adding a ring system to a planet is vital to helping gases high in the atmosphere, as the ring system particles serve as condensation and deposition nuclei for the gas molecules. The Moons of Mars exist in a temperature range which is below the freezing point of water. Phobos and Deimos have been recorded at temperatures around negative 4 degrees Celsius (−4 C), when exposed to sunlight, and around negative 40 degrees Celsius (−110 C), when not exposed to sunlight. This entire range is below the freezing point of water. However, in outer space, in extremely low pressure, the conditions are not optimal for water to freeze, independent of nuclei. Water can be supercooled to negative (−50 C), and remain in a gaseous state, if it lacks condensation/deposition nuclei. The ring system particles function as deposition and condensation nuclei. They are able to bind atmospheric molecules by adsorption, absorption, and other intermolecular forces such as dipole attraction.

Using ring particles that have polarity or high electronegativity difference (ionic, covalent), will help retain polar atmospheric molecules such as H2O, and ions like H+ and OH−. Silica/sand has a high electronegativity difference, which makes it useful, as the atoms share charges unevenly. Dirt, dust, clay, or any material useful for seeding clouds as a condensation nucleus, such as silver iodide, could also be useful for particles in a ring system. Silver iodide is also useful because it is a fast ion conductor. Carbohydrate based material including glucose, cellulose, paper, and cotton could also be interesting candidates. They essentially are composed of a carbon chain, connected to the components of water, H+ and OH−, making them hygroscopic. Organic, protic ionic plastic crystals, and salts are also useful, because they can bind Hydrogen protons (H+). The Solar Wind is composed largely of Hydrogen protons. These conductors are a special class of conductors. They are essential to life, and are found in DNA, fertilizer, and cell membranes. Dihydrogen phosphate, imidazolium, ammonium, guanidinium, and choline are interesting candidates to use for terraforming, because they are the building blocks of life on Earth. Ionic liquids made from these materials could be harnessed to create a conductive liquid in space, as ionic liquids are non-volatile. The class of ionic liquids, which may be used to create a conductive ring, is not limited only to organic, protic ions.

To build a more defined ring around a planet, polymers are also a good choice, as they can bind their monomer components together in larger chains. Polymerization can sometimes be activated by ultraviolet light, in order to stimulate the cross-linking process. As a result, polymers may be useful as they are likely to bind together, due to their exposure to sunlight in space. As will be explained later, polymers can be especially useful to construct a ring system which can conduct electricity, and create an oppositional magnetic field.

Ring systems normally are maintained by a planet's satellites, which exert orbital resonance on the ring system's particles. For the gas giants, the satellites that help bind the ring system weigh around 10\hat{ }15 kg on average, and normally range from 10\hat{ }12 kg to 10\hat{ }18 kg. Mars' moons, Deimos and Phobos are actually incredibly well-fitted to maintain a ring system, since they orbit in the equatorial plane, and weigh around 10\hat{ }15 kg and 10\hat{ }16 kg respectively. Mars does not have a natural ring system. Mars' Moons however, could maintain a ring system. An artificial ring system could function by relying on Mars' natural moons. This invention is not limited to a ring system dependent on Phobos and Deimos. It would be beneficial to add artificial satellites to supplement Mars' natural moons, both at the Lagrangian points of Mars' moons, and in orbits at other altitudes, to stabilize an artificial ring system comprised of particles. An artificial ring system could function, utilizing an assembly of completely artificial satellites. For logistical reasons, Mars' natural moons, Phobos and Deimos, should be preserved.

Adding artificial satellites in a ring system would also be beneficial, for multiple reasons. First, artificial satellites can help maintain ring systems, due to their gravity, and orbital resonance. Adding artificial satellites into different level orbits in Mars' equatorial plane, would help supplement the orbital resonance of Mars' natural moons, Phobos and Deimos. Most ring systems are maintained due to the orbital resonance between the ring particles, and the orbiting satellites. Satellites which maintain ring systems due to their gravitational influence, are called shepherd satellites. In this manner, artificial satellites can serve as ‘shepherd satellites’ for ring particles at different orbital radii. Artificial satellites at different level orbits in the ring system, would exert their gravitational influence on ring particles near those orbits.

Artificial satellites can also be used to thicken a ring system composed of particles. Artificial satellites can thicken a ring system, by orbiting at or around a stable orbital point. The gravitational influence of the satellite will expand the height of the ring system. Lagrange points are points of orbital stability between two celestial bodies. Specifically, they are five points at which objects can stabilize, due to the balance between the alternate bodies' gravitational fields. There are five Lagrange points, relative to a secondary celestial body's orbit around a primary celestial body. Lagrange points exist at intervals of the Moon's orbit around the Earth, as well as intervals of the Earth's orbit around the Sun. The same is true for Mars: Lagrange points exist at intervals of Phobos' orbit around Mars, Deimos' orbit around Mars, and Mars' orbit around the Sun. The L1, L2, and L3 Lagrange points are lined up in the same line as the first and second celestial body. The L1 Lagrange point is between the primary celestial body and the secondary celestial body. The L2 Lagrange point is lined up behind the secondary celestial body, in its relationship to the primary celestial body. The L3 Lagrange point is 180 degrees opposite the second celestial body in orbit. Basically, it is directly lined up behind the primary celestial body, in relation to the second celestial body. The L4 and L5 Lagrange points exist at 60 degree intervals, both in front of, and behind, the secondary celestial body in its orbit around the primary celestial body. Therefore, in relation to Phobos' orbit around Mars, these points exist 60 degrees in front of Phobos, and 60 degrees behind Phobos, in its orbit around Mars. The same points also exist for Deimos, in relation to its orbit around Mars.

Due to the orbital stability of these points, smaller artificial satellites orbiting at or around these points can exert gravitational influence on ring particles. Placing artificial satellites at the Lagrange points of Mars' Natural Moons, can help supplement their mass and gravitational influence on ring particles. Placing artificial satellites in orbit around these Lagrangian points, so that they orbit in a third dimension, or second plane, would expand the height of a ring system composed of particles. There are many different types orbits of artificial satellites that could accomplish this task. Placing artificial satellites in elliptic or circular orbit at these points would increase the height of the ring systems. Placing multiple artificial satellites in orbit, at or around the same Lagrangian point, would also help the artificial satellites' maintain their orbital stability in a three dimensional orbit.

An artificial ring system can also be used to help maintain a magnetic field around a planet. This is a crucial step in terraforming Mars, as the planet lacks a magnetic field to shield it from the Sun's Solar Wind, and other Galactic Cosmic Rays from other universes and stars. The Sun generates its own magnetic field, which is spread out across the Solar System. The Sun's magnetic field is complex, flowing from the polar north to the polar south, and constantly changing in orientation. The Sun also emits the Solar Wind, which is a plasma of charged particles. The Solar Wind is the primary cause of atmospheric loss on Mars. The Solar Wind plasma is tied to the Sun's magnetic field lines.

There are a few ways to maintain a magnetic field, by using an artificial ring satellite system.

One way to use an artificial ring system to maintain a magnetic field, is to create a ring system comprised of electrically conductive, superconductive, or semi-conductive, material. The ring may be an assembly of completely connected satellites, or flow as a system particles at a certain orbital radius, as electricity can flow through vacuums. It is a commonly understood phenomenon that magnetic fields surround flowing current. Conducting electricity through a ring around a planet, will create a magnetic field to shield the planet from the Sun's radiation, very much in the same way, that any loop of current creates a magnetic field. This artificial magnetic field will also resemble the type of natural magnetic field that would be produced by an internal dynamo.

Placing a ring around a planet, comprised of electrically conductive material, will help shield the planet from the Sun's changing magnetic field, and the Solar Wind. A magnetic field can induce a current through electrically conductive material, if the conductor moves in reference to a magnetic field. Change in the magnetic flux through a conductor induces an oppositional current, and thus an oppositional magnetic flux, due to the principles of conservation of energy. Thus, placing an electrically conductive ring around a planet, will induce oppositional current, and oppositional magnetic flux, against changes in the Sun's magnetic field.

Objects in space also gain charge, and magnetic fields due to their exposure to space, in a process called space charging. The Sun's magnetic field radiation that is present throughout the Solar System, helps induce current through a conductive ring system. A current can also be manually induced through a conductive ring system, to give the ring system a custom current, and magnetic field. Current may be manually induced by rotating magnetic fields around the ring system. Commutators may be used to maintain a steady direct current. A current may also be manually induced by shading a portion of the conductive ring from sunlight, and creating a temperature gradient. Placing a ring system in the ecliptic plane, where a portion of the ring is blocked from the sun's light, will create an electric potential across the ring, and induce current.

A good material to construct a ring capable of conducting current, is a conductive polymer. A conductive polymer is an organic polymer which can also conduct electricity. Creating a ring out of a conductive polymer, would help protect a planet from changes in magnetic flux from the Sun's magnetic field, due to the conservation of energy, and Lenz's Law. Changes in magnetic flux would induce an oppositional magnetic field through a ring comprised of a conductive polymer. Exposure to sunlight can also induce cross-linking in polymers, which allows polymers to bind in a manner that makes them adaptable for a ring system.

A polymer such as polyphenylene vinylene would be especially useful, as it can produce singlet oxygen from interaction with very small amounts of oxygen, that might be found in space. It could be a useful proponent, as it can produce o-zone as a by product, which is essential atmospheric ingredient in terraforming. It can also be assembled into a crystalline thin film. Furthermore, polyphenylene vinylene may be doped with iodide in order to increase its electrical conductivity. As mentioned earlier, silver iodide is a unique compound commonly used for cloud seeding. Silver iodide is a fast ion conductor, which means it has mobile ions.

Other types of polymers, such as PVC and PPD, may be useful candidates with which to create a conductive ring around Mars.

Another factor that should be considered, is that an electrically conductive rings can be used to help generate atmospheric pressure. Magnetic fields generate pressure, very similar to atmospheric pressure. Magnetic pressure is measured in the same units as normal atmospheric pressure. An artificial ring can help sustain atmospheric pressure around a planet, as the magnetic field strength within a current loop, becomes strongest in the center of the current loop. Thus, the pressure would grow, towards the center of the planet. An electrically conductive ring can be used to create a pressure seal around the planet, to trap gases, and make the planet's atmosphere more hospitable to humans.

Another way to create an electrically conductive ring around a planet, is by using solenoids. Solenoids are electrical rings that bend in multiple spirals, where the number of loops increases the strength of the magnetic field. Creating a ring of smaller electrically conductive solenoids, would create an induced magnetic field, oppositional to the Sun's magnetic field, around a celestial body. The solenoids can be slid into one another, and locked together by placing a material within the overlap. The material locks may be magnetic dipoles, so that symmetric magnetic locks constructively interfere to induce a larger dipole magnetic field. The magnetic pressure within the induced magnetic field would press the shape of the larger ring into a circle. A system of solenoids, or smaller rings, would be useful, as it would be easy to construct, and deconstruct. The solenoids or rings which construct the larger electrically conductive ring, can be perfect circles, or elongated ellipses. Alternating the number of loops within adjacent solenoids, so that solenoids have alternating loop numbers, may also help the solenoids stick together.

Another method to create a conductive ring system, is to create a ring system comprised of positively charged, and negatively charged terminals. These are the types of terminals found in batteries, solar cells, and capacitors. A benefit of using batteries, or charged cells, is that they don't require a change in magnetic flux, in order to induce current. A stable magnetic field can be used to help induce current between terminals of different batteries. Placing a magnet between the positive terminal of one battery, and the negative terminal of another battery, induces current to flow between the batteries. The charged terminals of the batteries are attracted to one another as a result of the current. The battery cells, or solar cells, can also be constructed with material, ferromagnetic or paramagnetic, so that the terminals are attracted to the magnets. Magnets help lock the charged terminals of different cells together, as well as induce current. A system of magnets and batteries could host a constructible, and de-constructible, conductive ring system.

Solar Cells are the best types of batteries to use, in order to create a conductive ring of current. Solar Cells acquire charge from sunlight, due to the photovoltaic effect. They can be constructed on flexible, or rigid materials. And they operate like batteries, with circuits creating a voltage between positive and negative terminals. Solar cells typically utilize the photovoltaic characteristics of silicon, though they are not limited to only silicon variety. Nickel is a material which is used to plate the circuits of solar cells. Using solar cells with nickel plates would allow the terminals to clipped together, due to their interaction with magnetic fields. Nickel plated silicon cells would be useful because Nickel is ferromagnetic in its pure form. Many other materials, with ferromagnetic, or paramagnetic properties, may be useful as alternatives to Nickel.

A magnetic joint/hinge is a useful way to link up battery cells, solar cells, and capacitors, in order to produce a conductive ring, as it allows for a de-constructible, and re-constructible apparatus, which can be easily managed in space. A magnetic hinge also allows flexibility to the structure. A magnetic hinge can link the positive terminal of a single solar cell, or group of solar cells (module/panel), to the negative terminal of a different solar cell, or group of solar cells (module/panel), induce current between the cells, and conduct electricity itself. Magnetic hinges can connect terminals of single modules. They can also, preferably, connect terminals of module sets, where each module set contains a group of symmetrically aligned modules. Multiple sets of symmetrically aligned cells/modules/panels may be placed within the same set of magnetic hinges. In this way, magnetic hinges may connect a group of positive terminals from symmetric solar modules, to a different group of negative terminals of symmetric solar modules. Attaching multiple cells/panels/modules is useful, as it helps keep the magnets symmetrically aligned. Placing multiple solar cells/modules/panels, symmetrically aligned, between each magnetic hinge, helps lock the magnets in symmetrical alignment with one another, across terminals. Multiple symmetric modules may be placed in between each set of magnetic hinges, so that 2 positive terminals and 2 negative terminals are symmetrically aligned between magnetic joints. And the magnetic hinges connect the terminals of modules in groups of 2 or more.

For this invention, the solar panels, or array of solar panels, between the sets of magnets, should have their positive and negative terminals on opposite sides of their array, so that positive terminal of one group of cells/panels/modules, can be linked to the negative terminal of a different group of cells/panels/modules. Magnets are naturally attracted to each others opposite poles. One Magnet's North Pole will attract another Magnet's South Pole. Building a ring with alternating N/S and S/N poles may be useful. Asymmetric magnets may be used to connect a hinge, where the magnetic attraction between the two magnets, keeps the cells/batteries linked together, while conducting current. Asymmetric magnets can also be used in undulators, to create a ring system which utilizes lasers. However, assembling magnets in this manner may be subject to destructive interference. Practitioners may also prefer to limit the number of pole reversals between magnets.

Each hinge may also utilize a single magnet, or symmetrically aligned magnets, to attach the batteries, as the magnetic terminals, are still attracted to the magnet. A single magnet, or symmetric magnets, can be used to connect battery cells at each hinge, and conduct current. In these scenarios, there is a symmetric N and a symmetric S, across the magnets. Magnets are better able to amplify each other's magnetic fields, and constructively interfere, when they are symmetrically aligned. They also produce less radiation, and are more easily separated, when they are symmetrically aligned. For these reasons, symmetric alignment between magnets is preferable.

The conductive ring could use other types of battery cells or capacitors, other than solar panels. Iron Phosphate batteries, Nickel Hydride, and Lithium Ion batteries, could all be used to construct a conductive ring around a planet, in conjunction with magnetic hinges. As previously stated with solar cells, the batteries should be symmetrically aligned between symmetrically aligned magnetic hinges, in order to conduct a current in a ring around a planet. Positively charged, and negatively charged terminals, are attracted to the magnets as current flows through them, and especially when comprised of magnetic material. The attraction is strong enough to overcome the repulsion between the symmetrically aligned magnets. The symmetrical magnets induce current in batteries due to the difference in energy potential between the positive and negative terminals. Placing multiple sets of battery modules, in between each sequence of magnetic hinges, helps lock in symmetrical alignment of the magnets. The batteries do not have to be symmetrically aligned, but preferably, should be symmetrically aligned.

An insulator or dielectric may be placed between the charged terminals of the batteries and the magnets, to limit the amount of current flowing. Dielectrics are useful, because they are polarized by electric field, and can maintain the attraction between the magnets and charged terminals, while reducing current. Some common dielectrics which may be used include fused quartz, polystyrene, and insulation paper. The dielectrics used in space often become conductive, due to their exposure to radiation. This is known as radiation induced conductivity.

A ring comprised of a dielectric material, or material with electric resistance, may be placed between the conductive ring, and the planet, so as to help shield the planet from the current flowing in the ring system. Silica/quartz particles are a good choice for these insulator rings. There are many other materials, including carbohydrates, or clay, which could comprise the insulating material. These insulator rings could also double function as heat sinks, to transfer heat from an electrically conductive ring to the planet therein, such as Mars.

Batteries, solar cells and magnets of the conductive ring system, may also be constructed in an amended manner, to help keep them physically locked with the magnet, the dielectric medium, or with one another. The magnets, and the terminals of the batteries/capacitors in a manner that resembles a fixed hinge, slot, or joint. The components be constructed as circles, cylindrical, rectangles, squares, and other types of three-dimensional or two-dimensional polygon components. A cylindrical, circular, or round magnet is the best shape for a hinge between solar panels. A sleeve may be placed around the separate groups of modules, to keep them together.

Making the ring out of superconductive material would also be useful, since superconductive material is capable of ejecting a significant portion of an external magnetic field. Furthermore, superconductors generate magnetic fields when they spin. The gravity of the planet will cause a ring system comprised of superconductive material to rotate around the planet, as it orbits, and thus, generate a magnetic field. A solar shield would aid superconductivity, by shading a superconductive ring from sunlight, allowing it to remain cold. Superconductors normally need to be kept extremely cold, in order to lose their resistance to electricity. Thus, a solar shield is necessary to help the superconductor reach its superconductive state. There are a number of metals that become colder, as they are placed in a magnetic field, due to the magnetocaloric effect. These elements include: praseodymium nickel, silicon germanium, lanthanum based compounds, nickel based compounds, niobium based compounds, perovskites. Using these metals would also make cooling superconductors an easier task in space. In terms of structure, the Penrose Un-illuminable Room, which utilizes ellipses to create dark spots, would be a useful structure within which to house superconductors. It would allow for a solar shield to be placed around the superconductive material, and limit the amount of electromagnetic radiation that reaches the superconductive material. It should be noted that placing superconductors on the dark side of a planet, and preserving that position, would also help preserve superconductivity. Furthermore, using biconcave lenses, or biconcave structures, further helps preserve superconductivity, by bending light and electromagnetic radiation away from the location of the superconductors. Attaching a magnetic compass to a solar shield, on either side, helps the shield align with magnetic field lines. Superconductors often align with magnetic field lines, locking in a flux pinned state.

Solenoids, which are coiled helixes, can be useful tools due to their ability to amplify magnetic fields. Each loop in the helix of a solenoid amplifies the solenoid's magnetic fields. For this reason, solenoids can be used as artificial satellites, to trap plasma, charged particles, and gases in the Solar System. Solenoids can be used to trap charged particles of the Van Allen Radiation Belts, as well as atmosphere stripped by the Sun's Solar Wind. The induced magnetic moment in a solenoid is stronger, as a result of the number of current loops in the helix of a solenoid. The magnetic pinch, which results from the parallel lines of current, creates magnetic pressure, that is capable of trapping charged particles, in and around the magnetic field of a solenoid.

Solenoids can be used to capture escaping atmosphere caused by the Solar Wind. Solenoids can also be used to retain escaping atmosphere from the plasma fountains of the Polar Wind. A solenoid gains an induced magnetic field as a result of the charged particles, and magnetic flux of the Solar Wind. Manually running a current through the solenoid gives the solenoid an independent magnetic field, and is the best practice to retain the atmospheric gases. A bowl may be attached to the solenoid, to help retain atmosphere stripped and guided by the Solar Wind. Atmospheric gases retained by solenoids may be transported to other planets.

Solenoids are useful satellites to send into space, as they will collect Hydrogen, and other gases, on their journey through the Solar System. Giving the Solenoids a rotational velocity, helps strengthen the induced magnetic field. Electrically conductive solenoids are useful tools in the process of terraforming, as they can collect and trap gases on their trek between planets, due to their structure.

Additionally, Solenoids can also be used to strengthen a planet's magnetic field. They can be used to fix weak spots in Earth's Magnetic Field, like the South Atlantic Anomaly. This can be done by placing to placing solenoids at the bottom of Earth's South Atlantic Ocean, on the Ocean Floor They may also be placed into orbit as satellites.

Solenoids for this purpose should be comprised of paramagnetic elements. A paramagnet is a type of electrically conductive material which Paramagnetic Solenoids, which align with the Earth's magnetic field, so that the Earth's magnetic field lines flow through the solenoids, can amplify the Earth's magnetic field due to that alignment, and the paramagnetic properties of the solenoid. The Solenoid anchors, and satellites, can be made with Niobium or Zirconium. Niobium is useful, due to its strength, hypoallergenic and paramagnetic properties. It may be preferential to recycle Niobium. Zirconium can also be a useful material. Wires and alloys can be made from niobium, zirconium, and other superconductors. These two make an inexhaustive list of paramagnetic material which would be useful for this task.

The magnets placed at the bottom of the Ocean do not need to be solenoids. The material used to amplify the planet's magnetic field can be arranged in a vast array of shapes. A solenoid structure is useful, because the helix loops amplify the magnetic field, proportional to the number of structural loops of the solenoid.

The magnets, ferromagnets or paramagnets, used to amplify the planet's magnetic field, may be placed at the Ocean Floor, at the Earth's South Atlantic Anomaly, which is in the Atlantic Ocean. They also may be placed at a planet's magnetic poles, or sites which have been previously mined of magnetic material. Earth's magnetic poles are slightly inclined away from its geometric poles. Because Earth's magnetic field is maintained by an internal dynamo, its magnetic field lines, the field lines extend from Earth's core, outward into the atmosphere. The solenoids can align very easily with these magnetic field lines.

Artificial satellites may also be used to transfer heat from regions conducting current. This may be used in conjunction with an electrically conducting ring, or with an electrically conductive ionosphere. The thermoelectric effect, is the effect wherein, heat is exchanged as the result of the flow of electrical current. This effect can be harnessed, both to heat a planet, or to cool it down.

Heat sinks are materials with extremely low thermal conductivity, which can absorb a lot of heat, without changing much in temperature themselves. They are often used in electronics to absorb heat from circuits, to prevent overheating. Artificial satellites may be used as heat sinks, to transfer heat arising from electric current. An artificial heat sink can mitigate global warming in the Earth's atmosphere, by absorbing heat from electrical currents in the Earth's ionosphere. This type of heat sink would be built outward into space, as space is much colder than Earth's atmosphere. An artificial heat sink can also be useful, to transfer heat from an artificial, electrically conductive ring, into a planet like Mars, by placing the heat sink in between the planet and the electrically conducting ring. The artificial heat sink may function as a series of individual satellites, or as a continuous ring around a planet.

The Earth experiences joule heating, as a result of the interaction between the Sun's Solar Wind, and the Earth's atmosphere. The Earth's ionosphere is a region of the atmosphere which conducts electrical current. As a result of the thermoelectric effect, parts of the upper atmosphere absorb heat, due to the flow of current across the ionosphere. Earth's atmosphere is comprised largely of a material with extremely low thermal conductivity, water, which is a heat sink. Water is able to absorb lots of heat, without changing much in temperature. For this reason, it is considered a heat sink. However, the Earth's oceans are becoming increasingly warm, which gives rise to a number of weather related issues.

Artificial satellites, or an artificial ring system placed in orbit within the ionosphere, could serve as a secondary heat sinks, to reduce the heating of the Earth's Oceans. This secondary heat sink would limit the amount of joule heating occurring in Earth's atmosphere. In order to serve as a heat sink, a ring system should be comprised of material with low thermal conductivity. The best materials would also be light, and electrically conductive.

Silica Aerogel is the best candidate to use to construct a heat sink in the ionosphere, for many reasons. Silica has extremely low thermal conductivity, and is electrically conductive. Silica aerogel is also extremely light, and could orbit in the ionosphere relatively easily. An artificial heat sink, comprised of silica aerogel, will operate best if it is structured in a manner to allow more air to flow freely through the material. ‘Fins’ are an example of designs used in order to maximize heat transfer in a heat sink, by increasing the amount of air flowing through the heat sink. Aside from fin designs, a ring comprised of silica aerogel may also be embedded in other materials, like blankets, in order to give a ring heat sink more structure.

The silica aerogel may be attached to an array of solar panels, as the solar cells may be used to conduct current next to the heat sink. The solar cells would be arranged, so that their p-n junctions resemble that of a thermoelectric cooler. However, the solar cells are not necessary for the heat sink, as current flows freely through the Earth's ionosphere.

Other materials which could be used including other types of aerogels, polypropylene foam, water-ice, oils, fats, and metals like steel. Fused Quartz, normal silica and sandstone are also good options. For Earth, practioners may prefer silica aerogel over normal silica, to limit the amount of unintended cloud seeding, and to mitigate climate change. On Mars, where the planet is much colder, a heat sink comprised of sand/normal silica, may be preferable.

The primary electric jets in the Earth's ionosphere are located near the magnetic equator, and the N and S pole. Therefore an artificial ring heat sink would operate well the equatorial plane. Placing silica aerogel in orbit near the polar regions, would also be beneficial. The electric currents of the ionosphere flow at many different latitudes, so the artificial heat sink satellites are not limited to the equatorial plane and the poles. An artificial heat sink located at the polar regions, can be shaped as an artificial ring, as the polar electric jets orbit the poles in a loop.

Multiple artificial heat sinks may placed in orbit at different altitudes. Joule heating affecting the middle atmosphere primarily occurs around 85 km to 100 km above sea level. Therefore, placing a heat sink in orbit at this altitude would be beneficial. Aerogel would be capable of floating at this extremely low orbit, due to its lightweight, and updrafts in the surrounding air. Updrafts are the mechanism that keep clouds afloat. Artificial drone satellites may be used to guide the silica aerogel in orbit.

An artificial heat sink can be used to absorb heat at any level in the ionosphere where current flows, including altitudes in the mesosphere, thermosphere, and exosphere.

If traditional solar cells are not used with silica aerogel, silica aerogel composed of p type silicon and n type silicon may be staggered, in order to create positive and negative terminals, keep an ordered flow of electric current flow, helping keep the aerogel together.

Alternatively, rather than using the thermoelectric effect and electric current, another way to mitigate global warming is to place a ring system in the ecliptic plane, and shade a planet from sunlight. The ecliptic plane is the plane which includes the planet, and the Star around which the planet orbits. A ring system comprised of artificial particles, which block sunlight from the sun, can be used to shade a planet from Sunlight. This type of ring system would function by using silica/normal sand, or other dust particles. The Earth's Moon orbits in the ecliptic plane. Artificial ring particles placed in orbit, around the Earth, would be maintained by the Moon's orbital resonance. Furthermore, additional artificial satellites could be placed in orbit around the Lagrangian points of the Moon's orbit, to help thicken the ring system, and provide a more even shade from the Sun, which extends out from the ecliptic plane.

1) Process to terraform atmosphere, comprising steps:
Creating artificial ring system around a planet,
By placing artificial ring system particles in orbit around Mars,
Where artificial ring comprised of particles

2) Process to create artificial Magnetic Field, comprising steps:
Creating artificial ring around planet,
Where artificial ring comprised of electrically conductive polymer
And electrically conductive ring creates oppositional magnetic field in response to change in Sun's magnetic flux

3) Process to mitigate global warming with artificial heat sink, comprising steps:
Placing artificial satellites into orbit in Earth's ionosphere,
Where artificial satellites comprised of silica aerogel, material with low thermal conductivity and high electrical conductivity,
And artificial satellites absorbing heat from electrical currents flowing through Earth's ionosphere,
Reducing joule heating in the atmosphere.

4) Process to amplify Earth's magnetic field, comprising steps:
Placing array of solenoids material on sea-floor, at South Atlantic Anomaly,
Where solenoids comprised of paramagnetic, ferromagnetic material,
And solenoids amplify Earth's magnetic field.
